(19) United States
(12) Patent Application Publication
(10) Pub. No.: US 2003/0165272 A1
(43) Pub. Date: Sep. 4, 2003

(54) Data quantizing device for predicting whether or not quantized data will be 0 and image data compressing device using the same

(75) Inventor: Kazunari Akaogi, Chiba (JP)

Correspondence Address: OLIFF & BERRIDGE, PLC, P.O. BOX 19928, ALEXANDRIA, VA, 22320, US

(73) Assignee: KAWASAKI STEEL CORPORATION

(21) Appl. No.: 09/758,143

(22) Filed: Jan. 12, 2001

(30) Foreign Application Priority Data
Jan. 12, 2000 (JP) 2000-3368

(51) Int. Cl. G06K 9/36

(52) U.S. Cl. 382/239; 382/251

(57) ABSTRACT

The data quantizing device quantizes coefficients subjected to orthogonal transform using a quantizing table. The device includes a comparing unit for deciding whether or not quantized data will be ‘0’ by comparing the orthogonal transformed coefficients with corresponding coefficients in the quantizing table, and a control unit for controlling the quantization so that only the orthogonal transformed coefficients with the quantized coefficients of not ‘0’ are quantized. The image data compressing device employs this data quantizing device, and this results in not only curtailing power consumption but also increasing the processing speed.

### BACKGROUND OF THE INVENTION

The present invention relates to the technology of quantizing process utilized in JPEG (Joint Photographic Experts Group) as international standards for color still picture compression, MPEG (Moving Picture Experts Group) utilized as international standards for moving color picture compression and the like, and more particularly to a data quantizing device for predicting whether or not quantized data will be ‘0’, and an image data compressing device using the same.

A conventional data quantizing device will be described with reference to FIGS. 7 and 8. Incidentally, the coefficients shown in FIG. 8 represent data in the case of JPEG reported on page 166 of the “Interface” (CQ Publishing Company), December edition, 1991. In the case of JPEG, as shown in the conceptual block diagram of FIG. 7, original image data is reduced to a block 12 having 64 coefficients corresponding to image data of horizontal 8 pixels×vertical 8 pixels=64 pixels, for example.

Each step of quantizing process is performed with the block 12 as a unit. The 64 coefficients (FIG. 8(a)) within the block 12 are first subjected by an orthogonal transformer 14 to orthogonal transform in the horizontal direction before being stored in a memory 16. Subsequently, the coefficients are similarly subjected by an orthogonal transformer 18 to orthogonal transform in the vertical direction before being stored in a memory 20. Then each of the orthogonal transformed coefficients (FIG. 8(b)) is quantized (FIG. 8(c)) by a quantizer 22 using a quantizing table (FIG. 8(d)) 24.

During the quantization, the coefficients (FIG. 8(b)) stored in the memories after the orthogonal transform are read by zigzag scanning. Then the coefficients that have been read are divided by corresponding coefficients (FIG. 8(d)) in the quantizing table 24 and respectively approximated to the nearest integers (FIG. 8 (c)). The coefficient values in the quantizing table 24 corresponding to high-frequency components are made sufficiently greater than coefficient values corresponding to low-frequency components. By utilizing the human sense of sight that tends to make it difficult to discern between the higher-frequency components, greater compression and encoding effects can be obtained.

The quantized coefficients are output in the zigzag

### SUMMARY OF THE INVENTION

It is an object of the present invention to solve the foregoing problems based on the prior art, and to provide a data quantizing device capable of curtailing power consumption and increasing processing speed.

It is another object of the present invention to provide an image data compressing device for compressing image data in JPEG, MPEG and the like using the data quantizing device.

In order to accomplish the objects above, the invention provides a data quantizing device for quantizing orthogonal transformed coefficients by using a quantizing table, comprising:

a comparing unit for deciding whether or not quantized coefficients will be ‘0’ by comparing the orthogonal transformed coefficients with corresponding coefficients in the quantizing table; and

a control unit for controlling so that only the orthogonal transformed coefficients with the quantized coefficients of not ‘0’ may be quantized.

The comparing unit may include a shift circuit for shifting the orthogonal transformed coefficients as binary data, and a comparator for comparing the orthogonal transformed coefficients thus shifted with the corresponding coefficients in the quantizing table, and outputting as bit data results of comparison deciding whether or not the quantized coefficients will be ‘0’.

Preferably, the shift circuit operates to shift the orthogonal transformed coefficients as the binary data by one bit toward an upper bit side.

The control unit may include a quantization predicting register for storing results of comparison indicative of whether or not the quantized coefficients will be ‘0’, a memory for storing the orthogonal transformed coefficients, a read control circuit for reading the results of comparison from the quantization predicting register and causing only the orthogonal transformed coefficients with the quantized coefficients of not ‘0’ to be read from the memory, and a quantizer for dividing the orthogonal transformed coefficients read from the memory with the corresponding coefficients in the quantizing table so as to output quantized results.

The control unit may include a quantization predicting register for storing the results of comparison indicative of whether or not the quantized coefficients will be ‘0’, a memory for storing the orthogonal transformed coefficients, a read control circuit for reading the results of comparison from the quantization predicting register and causing only the orthogonal transformed coefficients with the quantized coefficients of not ‘0’ to be read from the memory, and a quantizer for dividing the orthogonal transformed coefficients read from the memory with the corresponding coefficients in the quantizing table so as to output quantized results.

The control unit may include a quantization predicting register for storing the results of comparison indicative of whether or not the quantized coefficients will be ‘0’, a memory for storing the orthogonal transformed coefficients, a read control circuit for reading the results of comparison from the quantization predicting register and causing only the orthogonal transformed coefficients with the quantized coefficients of not ‘0’ to be read from the memory, and a quantizer for dividing the orthogonal transformed coefficients read from the memory with the corresponding coefficients in the quantizing table so as to output quantized results.

The comparing unit may include a shift circuit for shifting the orthogonal transformed coefficients as binary data, and a comparator for comparing the orthogonal transformed coefficients thus shifted with the corresponding coefficients in the quantizing table, whereupon the comparator outputs ‘0’ when it decides that the quantized coefficients will be ‘0’ and outputs the orthogonal transformed coefficients when it decides that the quantized coefficients will not be ‘0’.

The control unit may include a memory for storing the output of the comparator, and a quantizer for quantizing only the orthogonal transformed coefficients of not ‘0’ read from the memory by dividing them by the corresponding coefficients in the quantizing table.

The quantizer may include a quantizing circuit for quantizing only the orthogonal transformed coefficients of not ‘0’, an all-0 detection circuit for detecting the orthogonal transformed coefficients of ‘0’, and a selector for selectively outputting the quantized coefficients which are output from the quantizing circuit according to results detected by the all-0 detection circuit or otherwise ‘0’.

The results of comparison are written into the quantization predicting register by using the address signals used to write the orthogonal transformed coefficients to the memory.

The results of comparison are read from the quantization predicting register by using address signals used to read the orthogonal transformed coefficients from the memory.

When the results of comparison are read from the quantization predicting register, 0-run length is obtained by counting the number of the results of comparison of successive ‘0’.

When output of the comparator is read, 0-run length is obtained by counting the number of successive ‘0’ coefficients.

An image data compressing device having

a data quantizing device for quantizing orthogonal transformed coefficients by using a quantizing table, the data quantizing device comprising:

a comparing unit for deciding whether or not quantized coefficients will be ‘0’ by comparing the orthogonal transformed coefficients with corresponding coefficients in the quantizing table; and

a control unit for controlling so that only the orthogonal transformed coefficients with the quantized coefficients of not ‘0’ may be quantized.

The comparing unit may include:

a shift circuit for shifting the orthogonal transformed coefficients as binary data by one bit toward an upper bit side, and

a comparator for comparing the orthogonal transformed coefficients thus shifted with the corresponding coefficients in the quantizing table, and outputting as bit data results of comparison deciding whether or not the quantized coefficients will be ‘0’, and

the control unit includes:

a quantization predicting register for storing decided results of comparison indicative of whether or not the quantized coefficients will be ‘0’,

a memory for storing the orthogonal transformed coefficients,

a read control circuit for reading the results of comparison from the quantization predicting register and causing only the orthogonal transformed coefficients with the quantized coefficients of not ‘0’ to be read from the memory, and

a quantizer for dividing the orthogonal transformed coefficients read from the memory with the corresponding coefficients in the quantizing table so as to output quantized results.

The comparing unit may include:

a shift circuit for shifting the orthogonal transformed coefficients as binary data, and

a comparator for comparing the orthogonal transformed coefficients thus shifted with the corresponding coefficients in the quantizing table; outputting ‘0’ in case where the comparator decides that the quantized coefficients will be ‘0’; and outputting the orthogonal transformed coefficients in case where it decides that the quantized coefficients will not be ‘0’, and wherein

the control unit includes:

a memory for storing output of the comparator, and

a quantizer for quantizing only the orthogonal transformed coefficients of not ‘0’ read from the memory by dividing them by the corresponding coefficients in the quantizing table.

### BRIEF DESCRIPTION OF THE DRAWINGS

FIG. 1 is a block diagram showing a conceptual configuration of an image data compressing device including a data quantizing device as a first embodiment of the present invention.

FIG. 2 is a table showing the results of comparison by a comparator according to the first embodiment of the invention in FIG. 1.

FIG. 3 shows an example of the contents of a quantization predicting register according to the first embodiment of the invention in FIG. 1.

FIG. 4 is a table showing an example of the state of 0-run length according to the first embodiment of the invention in FIG. 1.

FIG. 5 is a block diagram showing a conceptual configuration of an image data compressing device including a data quantizing device as a second embodiment of the invention.

FIG. 6 is a conceptual block diagram showing an embodiment of a quantizer according to the second embodiment of the invention in FIG. 5.

FIG. 7 is a block diagram showing an example of a conventional data quantizing device.

FIG. 8 is a conceptual diagram showing examples of the contents of coefficient at each of the steps performed in the data quantizing process.

### DETAILED DESCRIPTION OF THE INVENTION

A detailed description will now be given of a data quantizing device as a preferred embodiment of the present invention with reference to the accompanied drawings.

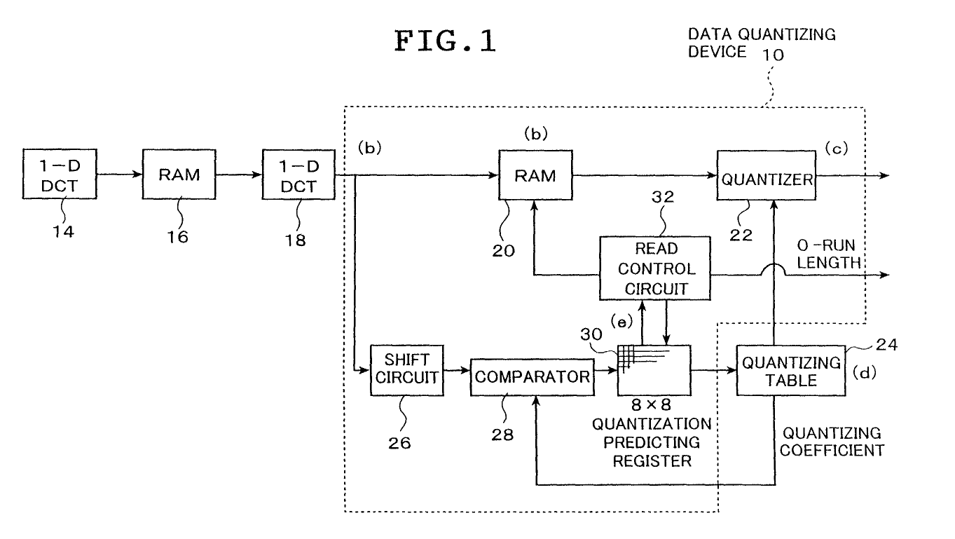

FIG. 1 shows a conceptual configuration of an image data compressing device including a data quantizing device as a first embodiment of the invention.

As given in the description of the prior art, orthogonal transformers 14 and 18, a quantizing table 24 and the like are also shown in FIG. 1 for convenience of describing the invention.

A data quantizing device 10 in FIG. 1 applies the invention to the prior art quantizer 22 of FIG. 7 and operates so that whether or not the quantized coefficients will be ‘0’ are decided by comparing the orthogonal transformed coefficients with the corresponding coefficients in the quantizing table 24 and only the orthogonal transformed coefficients whose quantized coefficients are not ‘0’ are quantized.

Accordingly, in comparison with the conventional quantizer 22, the data quantizing device 10 according to the invention comprises a shift circuit 26, a comparator 28, a quantization predicting register 30, and a read control circuit 32. Further, though a memory (RAM) 20 is installed within the data quantizing device 10, it may be arranged outside the data quantizing device. Incidentally, like reference characters designate like component elements of the image data compressing device including the prior art data quantizing device 42: namely, 14 and 18 denote orthogonal transformers (1-D, DCT); 16 and 20, memories; 22, a quantizer; and 24, a quantizing table.

In the image data compressing device including the data quantizing device 10 of FIG. 1, the orthogonal transformer 14 operates to transform coefficients corresponding to image data in a block to coefficients of frequency components by subjecting the former coefficients to orthogonal transform in the horizontal direction, for example. Each of the orthogonal transformed coefficients is stored in the memory 16. Similarly, the orthogonal transformer 18 subjects the coefficients read from the memory 16 to orthogonal transform in the vertical direction, for example. Each of the orthogonal transformed coefficients is supplied to the memory 20 and the shift circuit 26.

Then the shift circuit 26 subjects the orthogonal transformed coefficients as binary data to bit shifting. According to this embodiment of the invention, the shift circuit 26 shifts the orthogonal transformed coefficient value by one bit toward the upper bit side and doubles the value; actually, the shift circuit 26 is advantageous in that this can be realized by connecting n-bit binary data by one bit toward the upper bit side. The orthogonal transformed coefficients thus doubled are supplied to the comparator 28.

Before the orthogonal transformed coefficients are quantized, the comparator 28 compares the orthogonal transformed coefficients thus doubled by the shift circuit 26 with the corresponding coefficients in the quantizing table 24 as shown in FIG. 1 and decides whether or not the quantized coefficients will be ‘0’.

The coefficients in the quantizing table 24 are read out by using the address signals used in writing the orthogonal transformed coefficients to the memory 20. It is advantageous to read them without addition of any circuit.

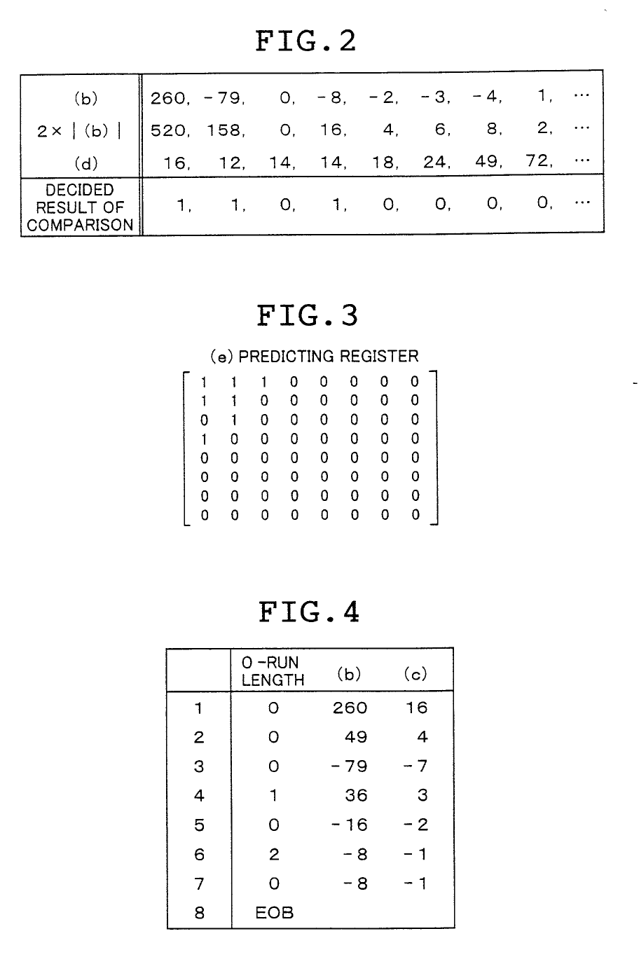

In case where a quantizer 22 operates to quantize coefficients by rounding off, for example, it is possible to decide that the quantized coefficients will not be ‘0’ when | (values of the orthogonal transformed coefficients (FIG. 8(b))/values of the coefficients in the quantizing table 24 (FIG. 8(d)) |≧0.5, that is, when 2 ×|(b)|≧(d). As shown by an example in FIG. 2, the results of comparison corresponding to the data of FIG. 8 indicate that ‘1’ will be output in case where the quantized coefficients are not ‘0’ according to this embodiment of the invention.

The shift circuit 26, the comparator 28, circuits necessary for reading coefficients from the quantizing table 24 and so forth constitute a comparing unit according to the invention. This embodiment of the invention is an example of the case where the quantizer 22 carries out the quantization by rounding off. In case where the quantizer 22 carries out the quantization according to a method different from this embodiment, the circuit may be modified by properly adjusting the values of orthogonal transformed coefficients to be compared by the comparator 28 and those in the quantizing table 24.

The results of comparison from the comparator 28 are supplied to the quantization predicting register 30. The quantization predicting register 30 stores the results of comparison supplied from the comparator 28; more specifically, it stores 8×8=64 of results of comparison as shown in FIG. 3 corresponding to the data in FIG. 8. In this case, since the address signals used to write the orthogonal transformed coefficients to the memory 20 are used to write the results of comparison to the quantization predicting register 30, addition of any circuit is not needed.

The read control circuit 32 subsequently scans the quantization predicting register 30 in zigzags to read the results of comparison and exerts control in such a manner that if the results of comparison are not ‘1’, that is, only the orthogonal transformed coefficients with the quantized coefficients decided to be not ‘0’ are read from the memory 20. In this case, the results of comparison are read in the zigzag scanning order by using the address signals used to read the orthogonal transformed coefficients from the memory 20.

Incidentally, 0-run length is normally obtained by counting coefficients of successive ‘0’ in the quantized coefficients. In the data quantizing device 10 of FIG. 1, on the other hand, the 0-run length can be obtained before the quantization as shown in FIG. 4 by an example corresponding to the data of FIG. 8 by counting the number of the results of comparison of the successive ‘0’ when the read control circuit 32 reads the decided results of comparison from the quantization predicting register 30. The processing hereinafter can thus be performed at high speed.

A control unit according to the invention is constituted of the following: the quantization predicting register 30, the read control circuit 32, and the circuits needed to read the results of comparison from the quantization predicting register 30 and also read the orthogonal transformed coefficients from the memory 20. However, the constitution of the control unit is not limited to the example described above but may be embodies in any other circuit configuration as long as only the orthogonal transformed coefficients with the quantized coefficients of not ‘0’ are quantized.

In case that the results of comparison read from the quantization predicting register 30 are ‘1’, the corresponding orthogonal transformed coefficients are read in the zigzag scanning order and supplied to the quantizer 22 as stated above. The quantizer 22 operates to quantize the orthogonal transformed coefficients supplied from the memory 20 using the quantizing table 24. Then the quantized coefficients and the 0-run length are supplied to an encoder (not shown) in the zigzag scanning order.

To the data quantizing device 10 of FIG. 1, a unit block, that is, 64 coefficients corresponding to the image data of 8×8=64 pixels are input on a block unit basis. Each of the coefficients in the block is first subjected by the orthogonal transformer 14 to orthogonal transform in the horizontal direction before being stored in the memory 16. The coefficients stored in the memory 16 are then read out and subjected by the orthogonal transformer 18 to orthogonal transform and supplied to the memory 20 and the shift circuit 26.

The orthogonal transformed coefficients are doubled by the shift circuit 26 and supplied to the comparator 28. Moreover, the coefficients in the quantizing table 24 are read by using the address signals used to write the orthogonal transformed coefficients to the memory 20 and supplied to the comparator 28. The doubled orthogonal transformed coefficients and the corresponding coefficients in the quantizing table 24 are respectively compared by the comparator 28 before the orthogonal transformed coefficients are quantized to decide whether or not the orthogonal transformed coefficients will be ‘0’.

Further, the results of comparison from the comparator 28 is supplied to the quantization predicting register 30 and stored in the quantization predicting register 30 by using the address signals used to write the orthogonal transformed coefficients to the memory 20. Then the coefficients corresponding to the respective orthogonal transformed coefficients are read from the quantizing table 24, and the orthogonal transformed coefficients supplied from the orthogonal transformer 18 are written into the memory 20 simultaneously when the results of comparison are written into the quantization predicting register 30.

Subsequently, the quantization predicting register 30 is scanned by the read control circuit 32 in zigzags, whereupon the orthogonal transformed coefficients are read by using the address signals used to read the orthogonal transformed coefficients from the memory 20. In case where the results of comparison are ‘1’, that is, only the orthogonal transformed coefficients with the quantized coefficients decided to be not ‘0’ are read from the memory 20 and supplied to the quantizer 22.

Moreover, the 0-run length is obtained by counting the number of the results of comparison of the continuous ‘0’ when the read control circuit 32 reads the results of comparison from the quantization predicting register 30. The orthogonal transformed coefficients read from the memory 20 are quantized by the quantizer 22 using the quantizing table 24. The quantized coefficients and the 0-run length are supplied to the encoder in the zigzag scanning order and subjected to variable length encoding.

Power consumption can thus be curtailed according to this embodiment of the invention when the results of comparison are ‘1’ because only the orthogonal transformed coefficients with the quantized coefficients of not ‘0’ are read from the memory 20 and quantized; in other words, the orthogonal transformed coefficients with the quantized coefficients of ‘0’ are not quantized. The processing speed can thus be increased to the extent mentioned above and as the 0-run length is obtainable beforehand, the processing speed can also be increased further.

The data quantizing device 10 according to the first embodiment of the invention and the image data compressing device using the same are basically arranged as set forth above.

Subsequently, a data quantizing device as a second embodiment of the invention will be described.

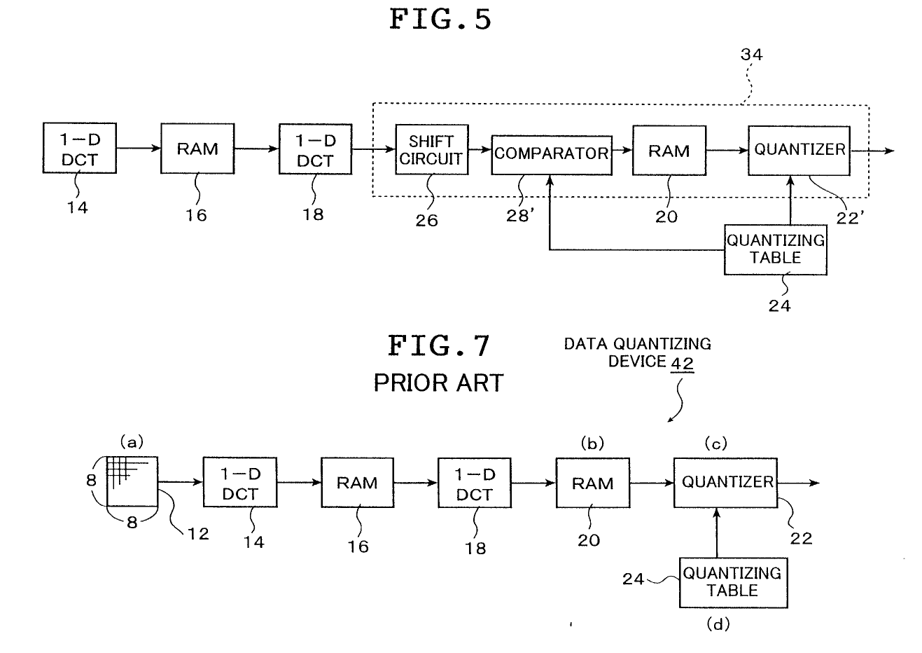

FIG. 5 is a block diagram showing a conceptual configuration of an image data compressing device including a data quantizing device as the second embodiment of the invention.

The data quantizing device 34 in FIG. 5 is different from the data quantizing device 10 in FIG. 1 in that the former is not equipped with the quantization predicting register 30 and the read control circuit 32; the orthogonal transformed coefficients are written into the memory 20 through a comparator 28′; and a quantizer 22′ operates to quantize only the orthogonal transformed coefficients whose quantized coefficients will not be ‘0’.

However, in an image data compressing device including the data quantizing device 34, the orthogonal transformers 14 and 18, the memories 16 and 20, the shift circuit 26, and the quantizing table 24 are entirely the same in configuration as the image data compressing device including the data quantizing device 10. Therefore, like reference characters in this embodiment of the invention designate like component elements of the image data compressing device including the data quantizing device 10 with the omission of the detailed description thereof.

Before the orthogonal transformed coefficients are quantized, the comparator 28′ compares the orthogonal transformed coefficients doubled by the shift circuit 26 with the corresponding coefficients in the quantizing table 24 as shown in FIG. 5 and decides whether or not the quantized coefficients will be ‘0’. The coefficients in the quantizing table 24 are read by directly using the address signals used to write the orthogonal transformed coefficients to the memory 20.

Then the comparator 28′ writes only the orthogonal transformed coefficients with the quantized coefficients of not ‘0’ into the memory 20, that is, in case where the results of comparison are ‘1’. Further, the comparator 28′ writes ‘0’ into the memory 20 instead of the values of the orthogonal transformed coefficients when the results of comparison are ‘0’, that is, in case where the quantized coefficients are ‘0’. In other words, the memory 20 is given the role of the quantization predicting register 30 in the data quantizing device 10 in FIG. 1.

The quantization predicting register 30 of the data quantizing device 10 in FIG. 1 can thus be omitted with the effect of reducing the circuit scale. Moreover, 0-run length is made obtainable likewise as in the case of using the quantization predicting register 30 of the data quantizing device 10 in FIG. 1 by counting coefficients of continuous ‘0’ when the orthogonal transformed coefficients are read by zigzag scanning from the memory 20, so that the processing speed is increased.

The orthogonal transformed coefficients stored in the memory 20 are read by zigzag scanning and supplied to the quantizer 22′. The quantizer 22′ operates to quantize only the orthogonal transformed coefficients with the quantized coefficients of not ‘0’. In other words, since ‘0’ has been written as the orthogonal transformed coefficients with the quantized coefficients of ‘0’, the quantizer 22′ operates to quantize only the orthogonal transformed coefficients of not ‘0’ supplied from the memory 20.

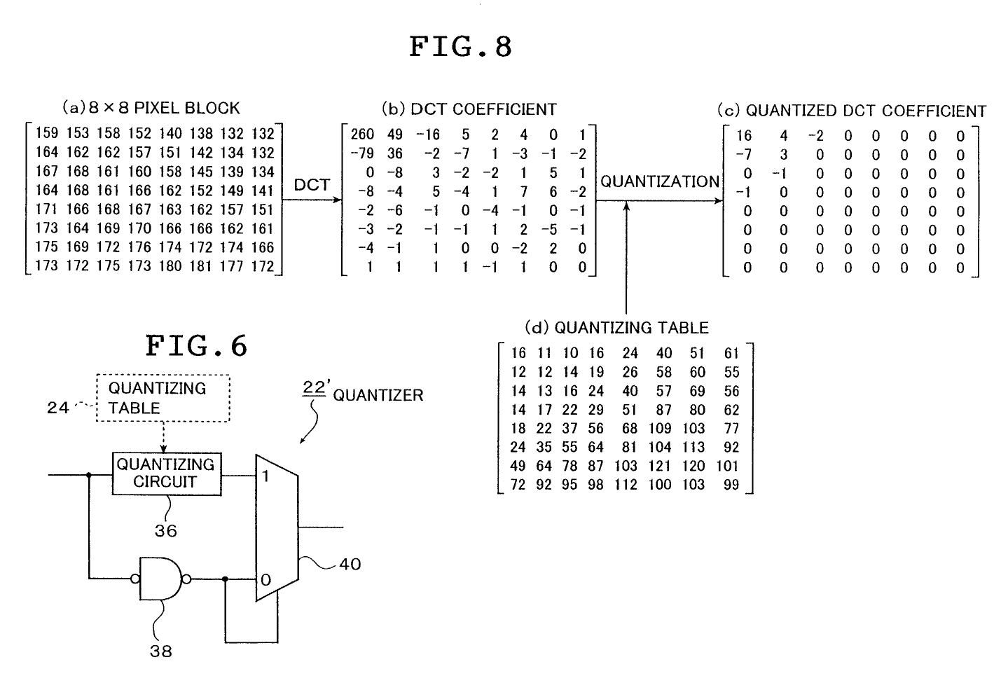

FIG. 6 shows a conceptual block diagram of an embodiment of a quantizer according to the second embodiment of the invention in FIG. 5.

As shown in FIG. 6, the quantizer 22′ comprises a quantizing circuit 36, an all-0 detection circuit 38, and a selector 40. The orthogonal transformed coefficients supplied from the memory 20 are input to the quantizing circuit 36 and the all-0 detection circuit 38.

First, the quantizing circuit 36 operates to quantize only the orthogonal transformed coefficients of not ‘0’, and the quantized coefficients are input to the input terminal 1 of the selector 40.

The all-0 detection circuit 38 operates to detect that the orthogonal transformed coefficients are ‘0’. The detected results are input to the input terminal 0 and the selective input terminal of the selector 40. In the case of the example of FIG. 6, ‘0’ is output from the all-0 detection circuit 38 when the orthogonal transformed coefficients of ‘0’ are detected, whereas ‘1’ is output from the all-0 detection circuit 38 when the orthogonal transformed coefficients of not ‘0’ are detected.

The selector 40 operates to selectively output the quantized coefficients from the quantizing circuit 36 or ‘0’ as quantized coefficients. When ‘0’ is output from the all-0 detection circuit 38, ‘0’ is output from the selector 40 and when ‘1’ is output from the all-0 detection circuit 38, the quantized coefficients that are output from the quantizing circuit 36 are output. Then the quantized coefficients are supplied to the encoder in the zigzag scanning order.

In the data quantizing device 34 in FIG. 5, the operation until the results of comparison is output by the comparator 28′ is same as in the case of the data quantizing device 10 in FIG. 1. In case where the results of comparison are ‘1’, that is, the orthogonal transformed coefficients with the quantized coefficients of not ‘0’ are directly written by the comparator 28′ to the memory 30, whereas in case where the results of comparison are ‘0’, that is, when the quantized coefficients are ‘0’, ‘0’ is written thereto.

The orthogonal transformed coefficients stored in the memory 20 are read by zigzag scanning and supplied to the quantizer 22′. In the quantizer 22′, only the orthogonal transformed coefficients of not ‘0’, that is, only the orthogonal transformed coefficients with the quantized coefficients of not ‘0’ are quantized by using the quantizing table 24, whereas ‘0’ is output without quantizing the orthogonal transformed coefficients of ‘0’. Then the quantized coefficients are supplied to the encoder in the zigzag scanning order and subjected to variable length encoding.

Since the orthogonal transformed coefficients with the quantized coefficients of ‘0’ are not quantized even according to this embodiment of the invention, power consumption can be curtailed to the extent mentioned above and the processing speed can also be increased. The quantizing circuit 36 is so arranged that it operates to quantize only the orthogonal transformed coefficients of not ‘0’ and the all-0 detection circuit 38 as well as the selector 40 forms the control unit according to this embodiment of the invention. However, the quantizer 22′, that is, the control unit is in no way restrictive.

The data quantizing device 34 and the image data compressing device are thus basically arranged according to the second embodiment of the invention.

Notwithstanding, the invention is not limited to the quantization in the image data compression such as JPEG and MPEG but may be applicable to the quantization and compression of any data, and any device for quantizing and compressing data.

Although a detailed description has been given of the data quantizing device and the image data compressing device using the same according to the invention, the invention is not limited to the aforesaid embodiments but may needless to say be changed and modified in various manners without departing from the spirit and scope thereof.

As set forth above in detail, the data quantizing device according to the invention is controlled so that by comparing the orthogonal transformed coefficients with the corresponding coefficients in the quantizing table to decide whether or not the quantized coefficients will be ‘0’ before the orthogonal transformed coefficients are quantized, only the orthogonal transformed coefficients with the quantized coefficients of not ‘0’ may be quantized.

Therefore, a wasteful quantizing process can be avoided as the data quantizing device according to the invention is usable for predicting whether or not quantized coefficients will be ‘0’, which results in curtailing power consumption and increasing the processing speed.

Further, the invention has the effect of attaining such an image data compressing device as to compress image data like JPEG and MPEG using the data quantizing device effective in accomplishing the purpose.

The invention also carries the advantage that the number of additional circuits is reducible and that the circuits therein are extremely easy to control.

What is claimed is:

1. A data quantizing device for quantizing orthogonal transformed coefficients by using a quantizing table, comprising:
a comparing unit for deciding whether or not quantized coefficients will be ‘0’ by comparing said orthogonal transformed coefficients with corresponding coefficients in said quantizing table; and
a control unit for controlling so that only said orthogonal transformed coefficients with said quantized coefficients of not ‘0’ may be quantized.

2. The data quantizing device as claimed in claim 1, wherein said comparing unit comprises a shift circuit for shifting said orthogonal transformed coefficients as binary data, and a comparator for comparing the orthogonal transformed coefficients thus shifted with the corresponding coefficients in said quantizing table, and outputting as bit data results of comparison deciding whether or not said quantized coefficients will be ‘0’.

3. The data quantizing device as claimed in claim 2, wherein said shift circuit operates to shift said orthogonal transformed coefficients as the binary data by one bit toward an upper bit side.

4. The data quantizing device as claimed in claim 1, wherein said control unit comprises a quantization predicting register for storing decided results of comparison indicative of whether or not said quantized coefficients will be ‘0’, a memory for storing said orthogonal transformed coefficients, a read control circuit for reading the decided results of comparison from said quantization predicting register and causing only the orthogonal transformed coefficients with the quantized coefficients of not ‘0’ to be read from said memory, and a quantizer for dividing the orthogonal transformed coefficients read from said memory with the corresponding coefficients in said quantizing table so as to output quantized results.

5. The data quantizing device as claimed in claim 2, wherein said control unit comprises a quantization predicting register for storing decided results of comparison indicative of whether or not said quantized coefficients will be ‘0’, a memory for storing said orthogonal transformed coefficients, a read control circuit for reading the decided results of comparison from said quantization predicting register and causing only the orthogonal transformed coefficients with the quantized coefficients of not ‘0’ to be read from said memory, and a quantizer for dividing the orthogonal transformed coefficients read from said memory with the corresponding coefficients in said quantizing table so as to output quantized results.

6. The data quantizing device as claimed in claim 3, wherein said control unit comprises a quantization predicting register for storing decided results of comparison indicative of whether or not said quantized coefficients will be ‘0’, a memory for storing said orthogonal transformed coefficients, a read control circuit for reading the decided results of comparison from said quantization predicting register and causing only the orthogonal transformed coefficients with the quantized coefficients of not ‘0’ to be read from said memory, and a quantizer for dividing the orthogonal transformed coefficients read from said memory with the corresponding coefficients in said quantizing table so as to output quantized results.

7. The data quantizing device as claimed in claim 1, wherein said comparing unit comprises a shift circuit for shifting said orthogonal transformed coefficients as binary data, and a comparator for comparing the orthogonal transformed coefficients thus shifted with the corresponding coefficients in said quantizing table, whereupon said comparator outputs ‘0’ when it decides that the quantized coefficients will be ‘0’ and outputs said orthogonal transformed coefficients when it decides that the quantized coefficients will not be ‘0’.

8. The data quantizing device as claimed in claim 7, wherein said control unit comprises a memory for storing the output of said comparator, and a quantizer for quantizing only the orthogonal transformed coefficients of not ‘0’ read from said memory by dividing them by the corresponding coefficients in said quantizing table.

9. The data quantizing device as claimed in claim 8, wherein said quantizer comprises a quantizing circuit for quantizing only the orthogonal transformed coefficients of not ‘0’, an all-0 detection circuit for detecting said orthogonal transformed coefficients of ‘0’, and a selector for selectively outputting the quantized coefficients which are output from said quantizing circuit according to results detected by said all-0 detection circuit or otherwise ‘0’.

10. The data quantizing device as claimed in claim 6, wherein said decided results of comparison are written to said quantization predicting register by using the address signals used to write said orthogonal transformed coefficients to said memory.

11. The data quantizing device as claimed in claim 6, wherein said decided results of comparison are read from said quantization predicting register by using address signals used to read said orthogonal transformed coefficients from said memory.

12. The data quantizing device as claimed in claim 6, wherein when said decided results of comparison are read from said quantization predicting register, 0-run length is obtained by counting the number of the decided results of comparison of successive ‘0’.

13. The data quantizing device as claimed in claim 8, wherein when output of said comparator is read, 0-run length is obtained by counting the number of successive ‘0’ coefficients.

14. An image data compressing device having
a data quantizing device for quantizing orthogonal transformed coefficients by using a quantizing table, said data quantizing device comprising:
a comparing unit for deciding whether or not quantized coefficients will be ‘0’ by comparing said orthogonal transformed coefficients with corresponding coefficients in said quantizing table; and
a control unit for controlling so that only said orthogonal transformed coefficients with said quantized coefficients of not ‘0’ may be quantized.

15. An image data compressing device as claimed in claim 14, wherein
said comparing unit includes:
a shift circuit for shifting said orthogonal transformed coefficients as binary data by one bit toward an upper bit side, and
a comparator for comparing the orthogonal transformed coefficients thus shifted with the corresponding coefficients in said quantizing table, and outputting as bit data results of comparison deciding whether or not said quantized coefficients will be ‘0’, and
said control unit comprises:
a quantization predicting register for storing decided results of comparison indicative of whether or not said quantized coefficients will be ‘0’,
a memory for storing said orthogonal transformed coefficients,
a read control circuit for reading the decided results of comparison from said quantization predicting register and causing only the orthogonal transformed coefficients with the quantized coefficients of not ‘0’ to be read from said memory, and
a quantizer for dividing the orthogonal transformed coefficients read from said memory with the corresponding coefficients in said quantizing table so as to output quantized results.

16. An image data compressing device as claimed in claim 14, wherein
said comparing unit comprises:
a shift circuit for shifting said orthogonal transformed coefficients as binary data, and
a comparator for comparing the orthogonal transformed coefficients thus shifted with the corresponding coefficients in said quantizing table; outputting ‘0’ in case where the comparator decides that the quantized coefficients will be ‘0’; and outputting said orthogonal transformed coefficients in case where it decides that the quantized coefficients will not be ‘0’, and wherein
said control unit comprises:
a memory for storing output of said comparator, and
a quantizer for quantizing only the orthogonal transformed coefficients of not ‘0’ read from said memory by dividing them by the corresponding coefficients in said quantizing table.
